(19) United States
(12) Patent Application Publication
(10) Pub. No.: US 2006/0136215 A1
(43) Pub. Date: Jun. 22, 2006

(54) Method of speaking rate conversion in text-to-speech system

(76) Inventor: Jong Jin Kim, Iksan (KR)

Correspondence Address: LADAS & PARRY LLP, 224 SOUTH MICHIGAN AVENUE, SUITE 1600, CHICAGO, IL, 60604, US

(21) Appl. No.: 11/290,908

(22) Filed: Nov. 30, 2005

(30) Foreign Application Priority Data
Dec. 21, 2004 (KR) 2004-109897
Jul. 15, 2005 (KR) 2005-64097

(51) Int. Cl. G10L 13/02

(52) U.S. Cl. 704/265

(57) ABSTRACT

A method of a speaking rate conversion in a text-to-speech system is provided. The method includes: a first step of extracting a vocal list from a synthesis DB (database), voicing the extracted vocal list in each speaking style constituted of fast speaking, normal speaking, and slow speaking, and building a probability distribution of a synthesis unit-based duration; a second step of searching for an optimal synthesis unit candidate row using a viterbi search, correspondingly to a requested synthesis, and creating a target duration parameter of a synthesis unit; and a third step of again obtaining an optimal synthesis unit candidate row using the duration parameter of the optimal synthesis unit candidate row, and generating a synthesized sound.

### BACKGROUND OF THE INVENITON

1. Field of the Invention

The present invention relates to a method of a speaking rate conversion in a text-to-speech system, and more particularly, to a method of a speaking rate conversion in a text-to-speech system, using a speaking rate-based duration model and a two-step unit selection process.

2. Description of the Related Art

As a conventional method of a speaking rate conversion of a text-to-speech system, there are methods for performing the speaking rate conversion using a frame unit-based superposition way by a frame unit-based OverLap & Add (OLA) technique (in particular, Synchronous OverLap & Add (SOLA) method), or partially providing an effect of varying the speaking rate conversion by differentiating a speaking rate-based break indexing. In the SOLA method, voice is analyzed in a unit of frame of 20 to 30 msec and, at the time of analysis, a frame rate is controlled (when the voice is controlled to be slow, the frame rate is set to be large, and when the voice is controlled to be fast, the frame rate is set to be small), and the analyzed frame is overlapped and added, thereby again generating a speaking rate-controlled voice. In an overlapping & adding section, a delay sample position having a maximal correlation between an earlier frame and a current frame is obtained, and the overlap & add is applied at its position, thereby controlling a speaking rate.

However, in the first method for performing the speaking rate conversion using the OLA technique, a uniform speaking rate conversion is performed over all sections of a synthesized sound without using an advanced knowledge for the speaking rate conversion. Accordingly, the first method has drawbacks as follows.

In an internal length of a phoneme constituting the voice, there exist a context dependent on the speaking rate and a context independent from the speaking rate according to its problem. In the conventional OLA technique, the speaking rate conversion of the unit of frame at all sections of the synthesized sound is performed without using the advanced knowledge. Therefore, even a duration of the context independent from the speaking rate conversion is modified, thereby needing much endeavor for recognition when a user intends to listen and recognize the synthesized sound whose speaking rate is converted.

For example, in case of Korean plosive, it is well known in many papers of a phonetic experiment that when a length of a closure of the plosive is long, it is heard as the plosive, and when the length of the closure is short, it is heard as a fortis plosive. That is, a normal sound ‘KimChi’ can be heard as ‘KkimChi’. In another example, in case of a fricative sound ‘ [symbol] ’, if a length of a frictional component is long, the fricative sound is heard as ‘ [symbol] ’, and if a length of a frictional component is short, the fricative sound is heard as ‘ [symbol] ’.

Therefore, if the OLA technique based on the unit of frame not using the advanced information is applied, there is a possibility of modifying the frictional component of ‘ [symbol] ’ in length from 60 ms to 40 ms and due to this, the user should apply even much endeavor for recognition (the endeavor for recognition refers to a phenomenon where since a different phoneme of the context are intervened into the synthesized sound whose speaking rate is converted, even though a content of a whole sentence is understood, attention is repeatedly paid to other sides due to an effect of the intervened different phoneme so that, when contents of a whole document are heard, its memorized degree is reduced).

In the second method for the speaking rate conversion, considering that person's break indexing (that is, a group of word-syllables spoken together) is varied depending on the speaking rate conversion, a different break indexing is performed depending on the speaking rate (that is, in the fast speaking, a large group of words is formed and subjected to the break indexing), thereby providing an effect of the speaking rate conversion.

However, this method can cause an effect where the sentence is tediously often subjected to the break indexing or is subjected to a too long breaking indexing, by simply differentiating only the break indexing, and has a limitation in application of a rate of the speaking rate conversion since the phoneme is not varied in length depending on the speaking rate conversion on a little more technological aspect.

### SUMMARY OF THE INVENTION

Accordingly, the present invention is directed to a method of a speaking rate conversion in a text-to-speech system, which substantially obviates one or more problems due to limitations and disadvantages of the related art.

It is an object of the present invention to provide a method of a speaking rate conversion in a text-to-speech system, in which a phoneme context dependent on the speaking rate conversion and a phoneme context independent from the speaking rate conversion can be automatically learned from training data so that, in synthesis, a variation of a speaking rate is automatically less reflected on the phoneme context independent from the speaking rate conversion, thereby reducing a phenomenon of being heard as other sounds, by solving a disadvantage of an OverLap & Add (OLA) technique of not utilizing information on the speaking rate conversion of a signal processing upper level.

It is another object of the present invention to provide a method of a speaking rate conversion in a text-to-speech system, in which a model for allowing learning from training data is created and used for synthesis, thereby allowing a length control of a duration dependent on a speaking rate in a unit of sub word, by solving a disadvantage of a speaking rate conversion technology whose breaking indexing rule is modified, where since a speaking rate cannot be converted in a unit of phoneme length, just only a speaking rate conversion of only a breaking indexing of a limited level is resultantly enabled.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a flowchart illustrating a conventional process of generating a synthesized sound in a synthesizer;

FIG. 2 illustrates a process of building a learning database (DB) of a speaking rate-based synthesis unit duration;

FIG. 3 illustrates a process of training a duration model dependent on a synthesis unit-based speaking rate;

FIG. 4 illustrates an example of a duration distribution of a synthesis unit having a characteristic of a duration dependent on a variation of a speaking rate;

FIG. 5 illustrates an example of a duration distribution of a synthesis unit having a characteristic of a duration independent from a variation of a speaking rate;

FIG. 6 illustrates a process of a speaking rate conversion;

FIG. 7 illustrates a process of extracting a target duration of a synthesis unit from a 1-pass optimal path;

FIG. 8 illustrates a process of obtaining a modified synthesis unit duration using a 1-pass result and a speaking rate-dependent duration model of a synthesis unit; and

FIG. 9 illustrates a process of searching for the most optimal synthesis unit candidate using a modified synthesis unit duration as target information, and its search result.

### DETAILED DESCRIPTION OF THE INVENTION

Reference will now be made in detail to the preferred embodiments of the present invention, examples of which are illustrated in the accompanying drawings.

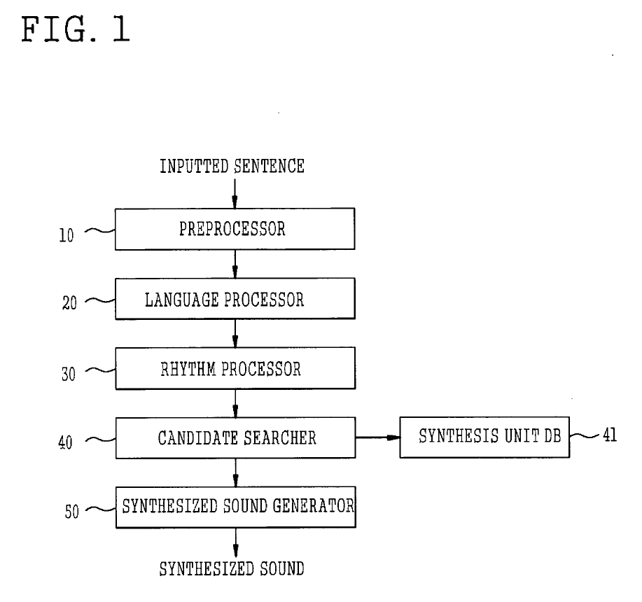

FIG. 1 is a flowchart illustrating a conventional process of generating a synthesized sound in a synthesizer.

As shown in FIG. 1, the text-to-speech system includes a preprocessor 10, a language processor 20, a rhythm processor 30, a candidate searcher 40, a synthesis unit database (DB) 50, and a synthesized sound generator 60, to sequentially process an inputted sentence and generate a synthesized sound. As described above, in a conventional art, an OverLap & Add (OLA) technique is applied to the generated synthesized sound in a unit of frame, thereby converting a speaking rate.

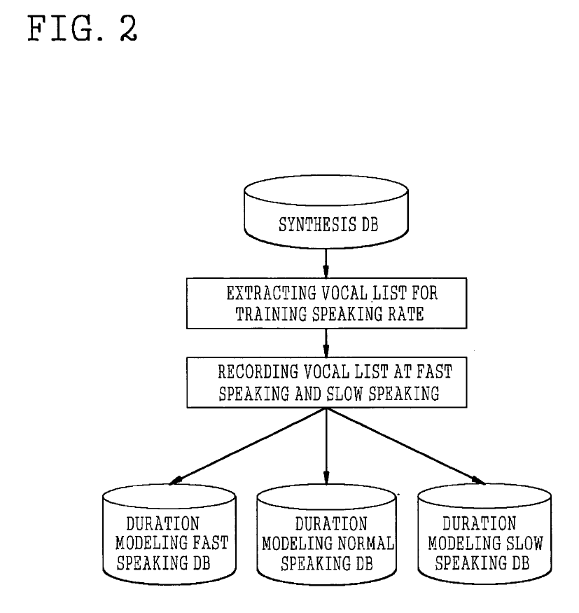

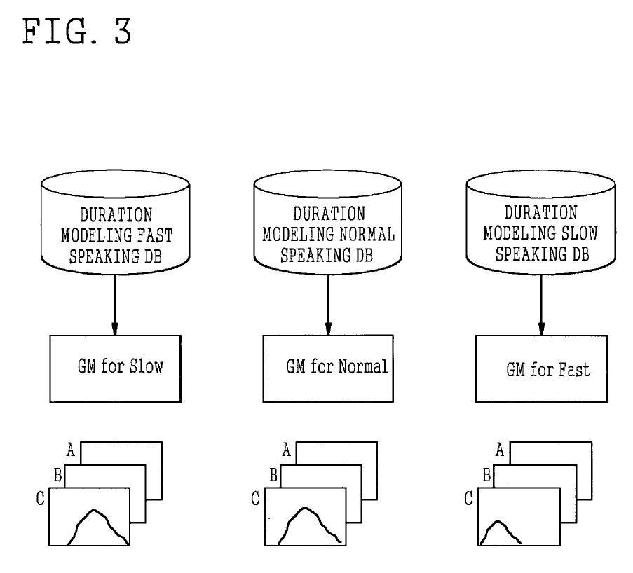

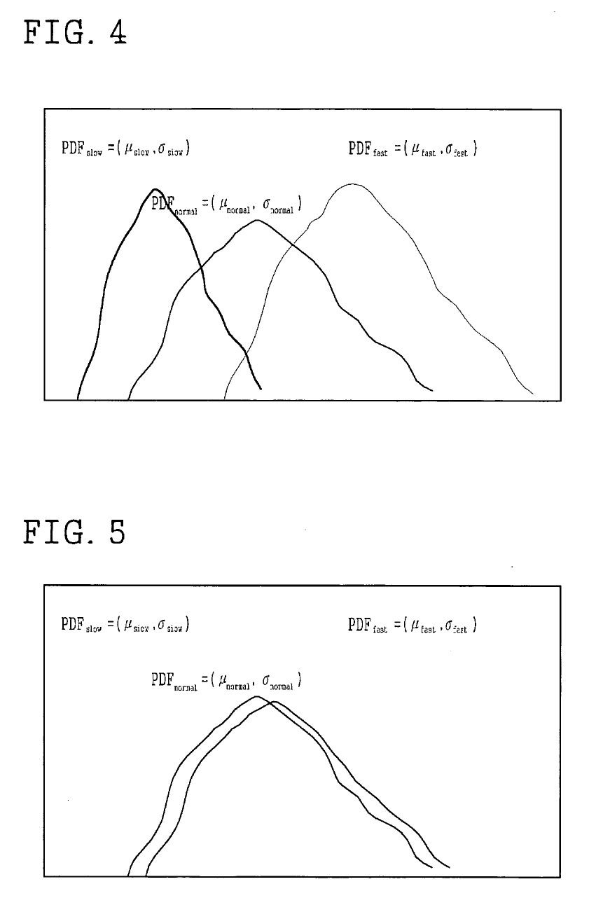

However, through a process of building a model for the duration of the synthesis unit dependent on the speaking rates represented in FIGS. 2 and 3, the present invention obtains a continuous probability distribution of the duration of the synthesis unit dependent on a variation of the speaking rate where the duration is varied in characteristic depending on the variation of the speaking rate as in FIG. 4, and a continuous probability distribution of the duration of the synthesis unit independent from the variation of the speaking rate where the duration is not varied in characteristic depending on the variation of the speaking rate as in FIG. 5. In the above obtained information, a synthesis unit where a shift range of a center value of the continuous probability distribution is “x” or less can be assumed to be the synthesis unit independent from the speaking rate, and a synthesis unit where the shift range is “x” or more can be assumed to be the synthesis unit dependent on the speaking rate. Here, the symbol “x” denotes a shift degree of the center value. The symbol “x” can be arbitrarily set, and its critical value can be introduced to determine whether the synthesis unit dependent on the speaking rate or not. If this information is utilized, a speaking rate conversion can be performed for only the speaking rate-dependent one of the synthesis units. Here, a process of obtaining the continuous probability distribution of the duration of the synthesis units dependent on the speaking rate is defined as a training process.

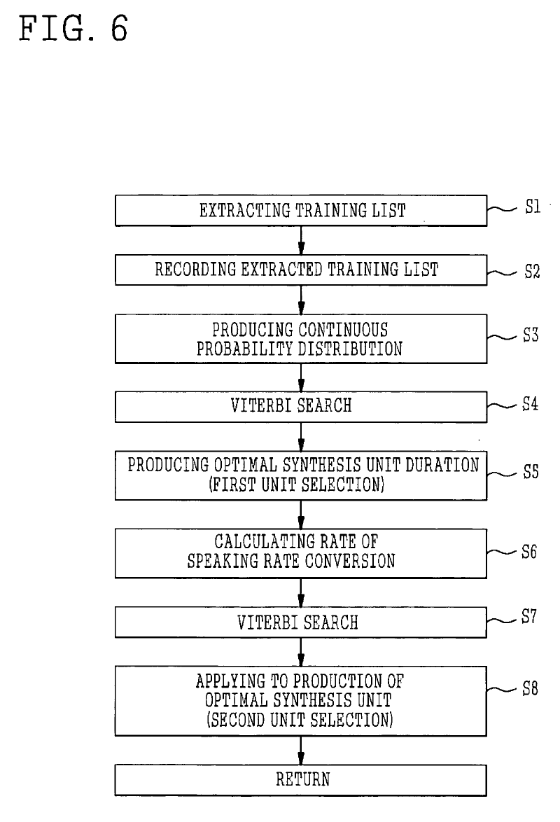

FIG. 6 illustrates a process of the speaking rate conversion.

Referring to FIG. 6, as shown in FIG. 2, an optimal training list for creating a synthesis unit-based duration training model is extracted from the synthesis DB (Step 1). The extracted training list is recorded at normal speaking, fast speaking, and slow speaking (Step 2). After that, as shown in FIG. 3, the continuous probability distribution of the speaking rate-dependent synthesis unit-based duration is obtained from each of a normally speaking training DB, a fast speaking training DB, and a slowly speaking training DB (Step 3).

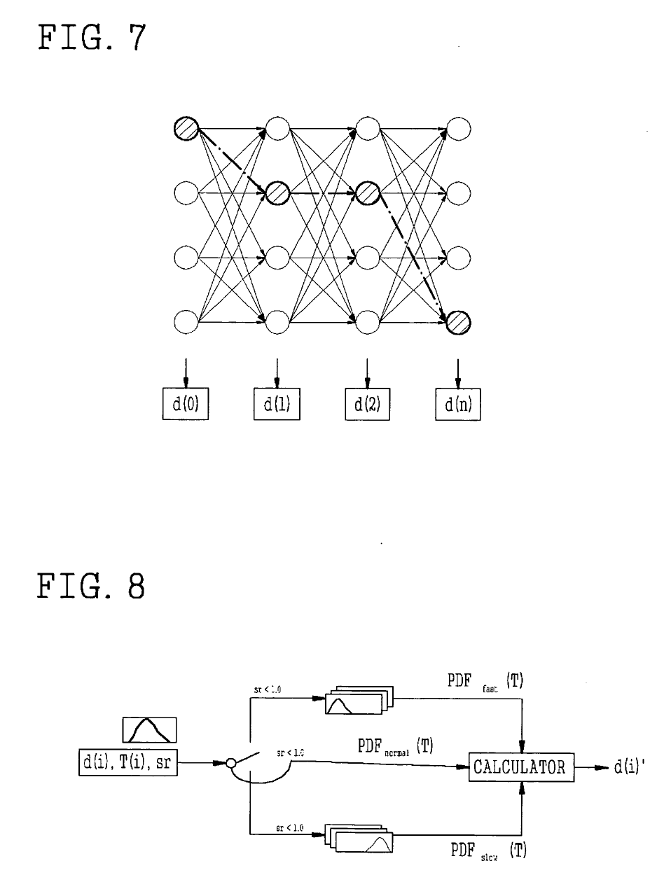

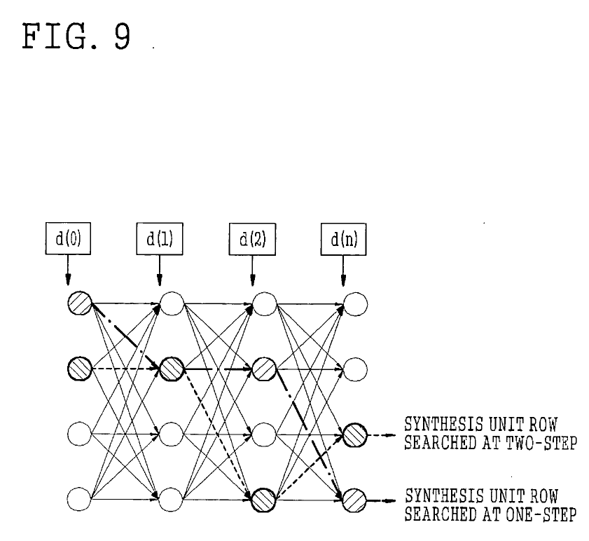

Consequently, in case where a user requests for synthesis, an optimal synthesis unit duration is produced using a viterbi search correspondingly to the user's request (Step 5). In the present invention, this process is defined as a first unit selection process. FIG. 7 illustrates a process of extracting a target duration of the synthesis unit from the 1-pass optimal path.

Next, in the duration model of the synthesis units at the selected slow speaking or fast speaking, a new target duration parameter of a final synthesis unit influenced from the speaking rate is finally produced, using the target duration and a continuous probability distribution of a duration of a synthesis unit candidate at the normal speaking (Step 6). A process of obtaining the new synthesis unit duration is in detail shown FIG. 8.

Consequently, an optimal synthesis unit candidate row dependent on the duration is again obtained using the viterbi search of the produced new target duration parameter (Step 7), and the synthesized sound is generated using the optimal synthesis unit candidate row dependent on the obtained duration (Step 8). Searching for the optimal synthesis unit candidate using modified synthesis unit duration as target information, and its search result are in detail illustrated.

Hereinafter, a process of the speaking rate conversion according to the present invention will be described using a detailed Equation.
T={Tᵢ; 1≦i≦N} [Equation 1]

In the Equation 1, “T” denotes the synthesis unit used in the synthesizer. On an aspect of actual embodiment, the “T” denotes a half phoneme, a phoneme, or a context dependent phoneme (byphone, triphone and the like). Additionally, in general, the synthesizer defines and uses an N (“N” is more than one) number of the synthesis units. In case where the phoneme is used as the synthesis unit in Korean, the numbers of consonant and vowel are “N”.
S={Sᵢ1≦j≦M} [Equation 2]

Here, “S” denotes the synthesis DB used in the synthesizer. In general, a large-capacity Corpus-based text-to-speech system processes the synthesis DB constituted of an M number of sentences, words, or phrases suitably to the synthesizer, and manufactures a synthesized voice. This synthesized voice is used to embody the synthesizer. In general, in the large-capacity Corpus, hundreds or thousands of sentences are used to develop the synthesizer. Therefore, “M” can be assumed to be hundreds to thousands.

In the present invention, in order to obtain a continuous probability density of the synthesis unit-based duration for the speaking rate-based duration, the fast speaking and the slow speaking for the substantially same content are required and therefore, it is not appropriate that the “M” number of sentences of the synthesis DB are all recorded at the fast speaking and the slow speaking. Therefore, though it is sufficient for the duration modeling, a “k” (even less than M) number of sentences should be extracted. A method for extracting the k number of sentences can be variously defined. In the present invention, the method for extracting the k number of sentences is not separately defined.

The above built vocal list is denoted by S_{K}, and can be defined as follows.
S_{K}={S′ₖ; 1≦k≦K<<M} [Equation 3]

The vocal list extracted from the Equation 3 are voiced at the fast speaking and the slow speaking, and are created as the training DB, respectively. Training data of the slow speaking for the S_{K} is defined as S_{K,slow}, and training data of the fast speaking is defined as S_{K, fast}.

Thus, a training set Sₜᵣₐᵢₙ can be defined as follows.
Sₜᵣₐᵢₙ={S_{K,slow}, S_{K,normal}, S_{K,fast}} [Equation 4]

Here, the S_{K,normal} means that it is not separately recorded, but extracted from an original synthesis DB. It is assumed that the original synthesis DB is recorded at the normal speaking rate (at a general speaking rate).

The training set Sₜᵣₐᵢₙ defined in the Equation 4 is used to define the continuous probability distribution of the duration of the synthesis unit for each of the speaking rates. Here, it is assumed that the continuous probability distribution is a Gaussian distribution.

For example, if there is any synthesis unit Tᵢ, since the same training set is used to build the training DB, the synthesis unit appears in the speaking rate-based training sets S_{K,slow}, S_{K,normal}, S_{K,fast} as much as the same number. Here, it is assumed that the number of the synthesis units To included in each of the training sets is “L”. In order to model the duration distribution of the synthesis unit Tᵢ included in each training set, it does not matter to estimate average and dispersion of the synthesis unit Tᵢ in each training set. If a maximum likelihood (ML) technique is applied to this, the estimation of the average and the dispersion of the duration distribution at the synthesis unit Tᵢ of each voicing style can be substituted for a sample average and a sample dispersion at each of the given training sets S_{K,slow}, S_{K,normal}, S_{K,fast}.

Therefore, through a basic statistical calculation process, the sample average and the sample dispersion for the Gaussian continuous probability distribution of the synthesis unit Tᵢ at the training DB built at each speaking rate can be calculated and obtained. The continuous probability distribution of the speaking rate-based synthesis unit can be expressed as follows.
PDP_{slow}(Tᵢ)={μ_{slow}(Tᵢ), σ_{slow}(Tᵢ)}
PDPₙₒᵣₘₐₗ(Tᵢ)={μₙₒᵣₘₐₗ(Tᵢ), σₙₒᵣₘₐₗ(Tᵢ)}
PDP_{fast}(Tᵢ)={μ_{fast}(Tᵢ), σ_{fast}(Tᵢ)} [Equation 5]

Through the above process, PDP_{slow}(Tᵢ), PDPₙₒᵣₘₐₗ(Tᵢ), and PDP_{fast}(Tᵢ) for the synthesis unit Tᵢ are finally obtained. Thus, a modeling process of the duration depending on the variation of the speaking rate for the synthesis unit Tᵢ is finished. This process is applied to an “L” number of the synthesis units, and the training process is finished.

Next, how the speaking rate conversion is performed using the above-built synthesis unit-based probability distribution for the speaking rate-based duration will be described.

A synthesized sentence (or any unit such as a syllable, a phoneme, a word, a phrase, a word-phrase, a paragraph, and a document) requested for the synthesis to any system is assumed to be Sₛ. Thus, the Sₛ can be defined as a sequence of the synthesis units as follows.
Sₛ=(Tₛ₀ Tₛ₁ Tₛ₂ . . . Tₛᵢ . . . Tₛₙ) [Equation 6]

That is, the inputted sentence Sₛ can be expressed as connection of an “n” number of synthesis unit rows.

The “n” number of the synthesis unit rows is created, and is used to perform the viterbi search considering a target cost function and a connection cost between the synthesis unit candidates. A process of finally obtaining the optimal synthesis unit T′ₛᵢ for the synthesis unit Tₛᵢ in the “n” number of the synthesis unit rows after the viterbi search is generalized in the large-capacity Corpus-based method, and therefore will not be described in detail. This process is defined as a first selection process. When an “n” number of optimal synthesis unit candidate rows finally selected through the first selection unit process is defined as S′ₛ, it can be defined as follows.
S′ₛ=(T′ₛ₀T′ₛ₁T′ₛ₂ . . . T′ₛᵢ . . . T′ₛₙ) [Equation 7]

The above obtained optimal synthesis unit candidate T′ₛᵢ is selected in the synthesis DB, and its duration can be previously known. Therefore, the duration of the optimal synthesis unit candidates T′ₛᵢ within the optimal synthesis unit candidate rows S′ₛ can be defined as d(T′ₛᵢ). This is illustrated in FIG. 7.

In next Step of the present invention, when U_{SR} denotes a rate of the speaking rate conversion requested by the user, if the U_{SR}<1.0, the speaking rate is converted to be fast, and the d(T′ₛᵢ) is converted into d′(T′ₛᵢ) using previously trained PDF_{fast}(Tᵢ) distribution information.

This process is expressed as in the following Equation:

$${d ( t )}^{′} = {μ}_{target} ( t ) + \frac{( d ( t ) - {μ}_{normal} ( t ) ) \cdot {σ}_{target} ( t ) \cdot {U}_{st}}{{σ}_{normal} ( t )} \qquad [ Equation 8 ]$$

where,
t: T′ₛᵢ.

If the d′(T′ₛᵢ) for all the optimal synthesis unit candidates T′ₛᵢ are obtained through the above process, a calculation process for the speaking rate conversion is finished.

Next, a second unit selection process is also a process of searching for the optimal synthesis unit candidate using the viterbi search of a general synthesizer. However, the second unit selection process is different from the first unit selection process in that the unit selection process is performed using the obtained d′(T′ₛᵢ) information of the Equation 8, as the duration parameter for the Tₛᵢ of the Sₛ=(Tₛ₀Tₛ₁Tₛ₂ . . . Tₛᵢ . . . Tₛₙ).

As described above, in the inventive method of the speaking rate conversion in the text-to-speech system, a small amount of the training DB recorded at each speaking rate is used to obtain a continuous probability distribution function for the duration of the synthesis unit, compare the obtained distribution function with the normal speaking, and observe the shift and the dispersion width of the center value, thereby being aware of as to whether the synthesis unit of any context is sensitively varied at any speaking rate to any degree.

In other words, in the duration distribution of any synthesis unit, if a distance between the center values at each speaking rate and a magnitude of a degree of dispersion are different as in FIG. 4, the synthesis unit is the synthesis unit of the context where the duration is varied dependently on the speaking rate, and if a difference between the center values at each speaking rate and a difference of the degrees of dispersion are less, the synthesis unit can be determined to be the synthesis unit widely used in the context less sensitive to the speaking rate. Or, when the critical value is introduced and the shift of the center value is “x” or more or a variation of the magnitude of the dispersion degree is “y” or more, it is defined to be the context dependent on the speaking rate so that only the synthesis unit of this dependent context can be also modified in duration using a conventional Synchronous OverLap & Add (SOLA) method. When the shift of the center value is “x” or less or the variation of the magnitude of the dispersion degree is “y” or less, it is determined to be the synthesis unit of the context not influenced from the speaking rate and this non-influenced portion is not allowed to employ the SOLA method, thereby solving a drawback of the conventional SOLA method in that a speaking rate conversion cannot be performed considering a context dependent on a speaking rate and a context independent from the speaking rate.

Further, the present invention has an advantage in that in the unit selection process of the synthesizer, the modified new duration target d(t)′ is used to perform a 2-pass search and generate the synthesized sound and therefore, the signal processing for the synthesized sound as in the conventional SOLA method is not required, thereby enhancing a real-time behavior of the speaking rate conversion.

A question on which, since the 2-pass search (second unit selection process) is performed, a long time would be taken due to two searches performed for the same search space can be provided, but it can be prevented from deteriorating the real-time behavior since the search space can be reduced by setting only the N-best of each optimal synthesis unit candidate as the search space, in the 1-pass search.

Further, the most remarkable feature of the present invention is that since the Equation itself for obtaining the d(t)′ includes a consideration of the context sensitive to the speaking rate and the context insensitive to the speaking rate, it is not required to create a separate training or expectation model for distinguishing these contexts.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of a speaking rate conversion in a text-to-speech system, the method comprising:
a first step of extracting a vocal list from a synthesis DB (database), voicing the extracted vocal list in each speaking style constituted of fast speaking, normal speaking, and slow speaking, and building a probability distribution of a synthesis unit-based duration;
a second step of searching for an optimal synthesis unit candidate row using a viterbi search, correspondingly to a requested synthesis, and creating a target duration parameter of a synthesis unit; and
a third step of again obtaining an optimal synthesis unit candidate row using the duration parameter of the optimal synthesis unit candidate row, and generating a synthesized sound.

2. The method of claim 1, wherein the first step comprises the steps of:
extracting an optimal training list for creating a synthesis unit-based duration training model, from the synthesis DB;
recording the extracted training list at the fast speaking and the slow speaking; and
obtaining a continuous probability distribution of a synthesis unit-based duration depending on a speaking rate, from a fast speaking training DB and a slowly speaking training DB.

3. The method of claim 1 or 2, wherein in the first step, the continuous probability distributions (PDP_{slow}(Tᵢ), PDPₙₒᵣₘₐₗ(Tᵢ), and PDP_{fast}(Tᵢ)) of the duration of the speaking style-based synthesis unit (Tᵢ) are expressed using the following Equation 5:
PDP_{slow}(Tᵢ)={μ_{slow}(Tᵢ), σ_{slow}(Tᵢ)}
PDPₙₒᵣₘₐₗ(Tᵢ)={μₙₒᵣₘₐₗ(Tᵢ), σₙₒᵣₘₐₗ(Tᵢ)}
PDP_{fast}(Tᵢ)={μ_{fast}(Tᵢ), σ_{fast}(Tᵢ)}. [Equation 5]

4. The method of claim 3, wherein the normal speaking is obtained from an original synthesis DB.

5. The method of claim 1, wherein the third step comprises the steps of:
producing a new target duration parameter of a final synthesis unit finally influenced from the speaking rate, using a target duration and a continuous probability distribution of a duration of a synthesis unit candidate at the normal speaking, in duration models of synthesis units at the selected slow speaking or fast speaking;
again obtaining an optimal synthesis unit candidate row dependent on a duration, using a viterbi search of the produced new target duration parameter; and
generating a synthesized sound using the again obtained duration-dependent optimal synthesis unit candidate row.

6. The method of claim 5, wherein a process of converting to the new target duration parameter d′(T′ₛᵢ) is expressed using the following Equation 8:
$${d ( t )}^{′} = {μ}_{target} ( t ) + \frac{( d ( t ) - {μ}_{normal} ( t ) ) \cdot {σ}_{target} ( t ) \cdot {U}_{st}}{{σ}_{normal} ( t )} \qquad [ Equation 8 ]$$
where
U_{SR}: rate of speaking rate conversion requested by user,
t: T′ₛᵢ.
